(19) United States
(12) Patent Application Publication
(10) Pub. No.: US 2005/0066997 A1
(43) Pub. Date: Mar. 31, 2005

(54) Self-contained mobile washing apparatus

(76) Inventor: Glyn E. Watford, Euless, TX (US)

Correspondence Address: Winstead Sechrest & Minick P.C., P.O. Box 50784, Dallas, TX, 75201, US

(21) Appl. No.: 10/606,136

(22) Filed: Jun. 25, 2003

(51) Int. Cl. B08B 3/02

(52) U.S. Cl. 134/10; 134/26; 134/34; 134/123; 134/94.1

(57) ABSTRACT

The present invention includes a mobile washing apparatus that has a vehicle housing and a tank within the vehicle housing. The tank is configured to capture waste water generated by washing a vehicle.

### TECHNICAL FIELD OF THE INVENTION

This invention generally relates to an environmentally safe mobile vehicle cleaning apparatus and in particular to a mobile car washing apparatus.

### BACKGROUND OF THE INVENTION

Without limiting the scope of the invention, its background is described in connection with vehicles and trailers and is best exemplified by methods and processes for washing vehicles in a mobile environment.

Consumers invest millions of dollars each year in vehicles for business and pleasure. Many of these consumers take great pride in maintaining the appearance of their vehicles. Consequently, manual and automated car washes, in addition to car washing services, have become very popular in recent years. Only a small percentage of vehicle owners, however, enjoy or can afford spending the time necessary to either wash their vehicles or wait for a service to wash their vehicles.

Some enterprising entrepreneurs have identified the need for mobile car washing services that will travel to vehicle owners instead of the more conventional manner of owners driving to a car wash. Mobile car washing services usually travel to a vehicle owner's home or place of business. This allows the owner to continue work or engage in other routine activities while their vehicle is being washed, waxed and detailed. Owners, therefore, receive a valuable service and can utilize their time for other important activities.

Mobile car washing services increase the potential for gaining customers by traveling to businesses or buildings that have large parking lots, which store many employees' vehicles. A high-profile washing service can generate a flood of customers in business parking lots as building tenants discover the value and convenience of mobile washing services and inform their friends and colleagues of the service.

Many businesses and building owners, however, have a concern that waste water, soaps and other chemicals from the mobile car washes will enter storm drains or natural runoffs and eventually pollute local water supplies or otherwise contribute to environmental degradation. The Environmental Protection Agency (EPA) may also impose strict regulations and penalties on businesses or building owners if they allow the waste water or chemicals from a mobile washing service to flow onto their property. These concerns effectively eliminate a large segment of the market for mobile washing services. Many business and building owners are simply not willing to allow mobile washing services onto their property at the risk of contaminating water supplies or incurring EPA imposed penalties.

Therefore, what is needed is a mobile washing apparatus that does not contribute to environmental contamination. Additionally, a method for washing vehicles at its particular location is needed that does not leave waste water or chemicals at the location.

### SUMMARY OF THE INVENTION

The present invention includes a mobile washing apparatus that has a vehicle housing and a tank within the vehicle housing. The tank is configured to capture waste water generated by washing a vehicle.

In another embodiment of the invention, a self-contained mobile vehicle washing apparatus has a vehicle housing. The vehicle housing has a floor, a roof and one or more walls. A drain is located within the floor of the vehicle housing and a tank for holding the waste water is connected to the drain.

In yet another embodiment of the invention, a method for washing a vehicle has the step of locating a mobile vehicle washing apparatus at a first location. The method also has the steps of accepting a vehicle into the mobile vehicle washing apparatus; washing the vehicle; and eliminating the waste water in an environmentally acceptable manner.

### BRIEF DESCRIPTION OF THE FIGURES

For a more complete understanding of the present invention, including its features and advantages, reference is now made to the detailed description of the invention taken in conjunction with the accompanying drawings in which like numerals identify like parts and in which:

FIG. 1 is a side view of mobile washing apparatus according to one embodiment of the present invention;

FIG. 2 is a back view of mobile washing apparatus according to one embodiment of the present invention;

FIG. 3 is a top view of mobile washing apparatus according to one embodiment of the present invention;

FIG. 4 is a partial cutaway view of mobile washing apparatus according to one embodiment of the present invention; and

FIG. 5 is a side view of mobile washing apparatus according to one embodiment of the present invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

A mobile washing apparatus according to the present invention has a vehicle housing that is configured to accommodate a vehicle such as a car, a truck, a sports utility vehicle (SUV), a boat, a personal watercraft, a motorcycle or any other type of vehicle that may require frequent or occasional washing. The mobile washing apparatus also has a tank to capture the waste water generated by washing these vehicles. After washing a vehicle, the waste water may be filtered and used to wash another vehicle or it may simply be stored within the tank until it can be properly disposed according to environmental regulations of a particular location.

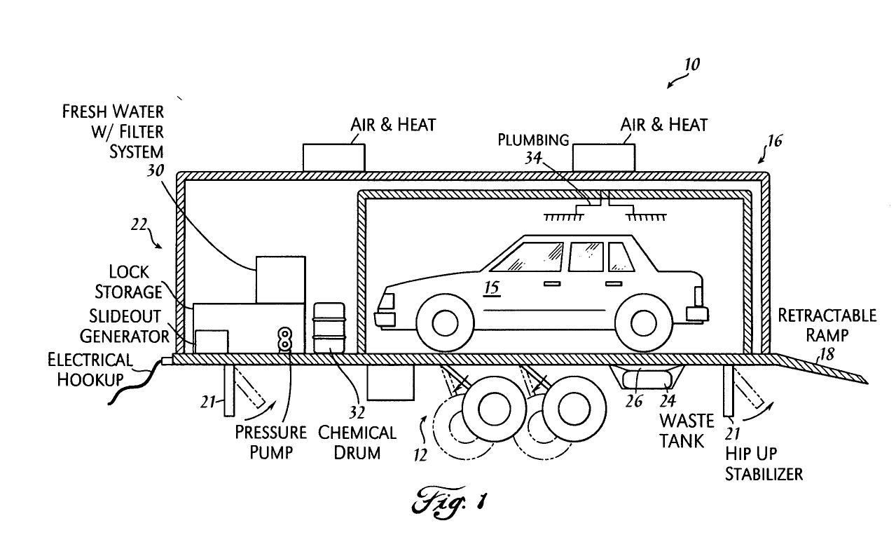

As depicted in FIGS. 1-3, a mobile washing apparatus 10 may be configured as a trailer 12 that may be towed behind a vehicle such as a truck or a tractor, for example. The trailer 12 may be any of a variety of commercially available trailers or the trailer 12 may be custom built according to a customers specifications. The trailer 12 may be built from steel, aluminum, carbon fiber, fiberglass, polymers and the like. Other materials will be apparent to those having ordinary skill in the art of trailer fabrication. It is advantageous to construct the trailer 12 from lightweight materials that have high strength. Lightweight materials save fuel costs required for towing the trailer 12 between locations.

The mobile washing apparatus 10 is configured to house a vehicle 15 so that the vehicle 15 may be covered and protected from environmental conditions such as sun and wind while the vehicle 15 is being washed. Both sun and wind may cause wash water to dry faster than desired, which may adversely result in water spotting on the finish of the vehicle 15. Additionally, professional vehicle detailers ideally do not wash vehicles that have a hot surface, which will result if the vehicle 15 is washed in bright sunlight.

Depending on the dimensions of the vehicle 15, the side walls 14 and top 16 of the mobile washing apparatus 10 may be configured to expand from the trailer 12 to give added space for an operator performing detailing work or to accommodate the vehicle 15. Expandable tops and sides for trailers and vehicles are known. For example, expandable sides and tops have been incorporated into recreational vehicles (RV's) to provide added interior space after the RV is stationary. Methods and systems for expanding the side walls 14 and top 16 of the trailer 12 will be apparent to those having ordinary skill in the art of RV fabrication.

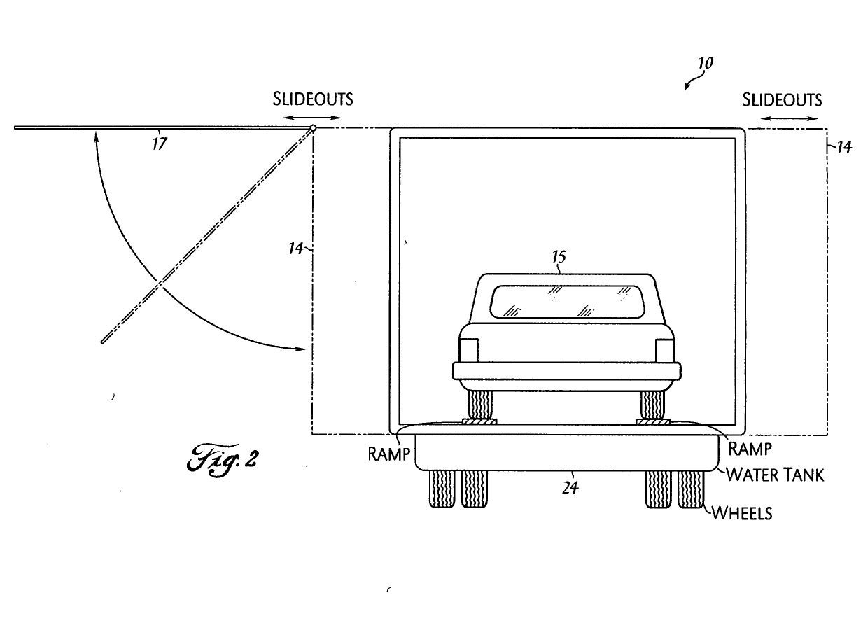

The side walls 14 may be configured to fold open to allow a customer or an audience to view the vehicle 15 as it is being washed. For example, as depicted in FIG. 2, a panel 17 in the side wall 14 may be hinged at the top and opened by an electric motor (not shown) or supported open by pneumatic struts (not shown). Alternatively, the panel 17 may be hinged at the sides or the bottom. If the panel 17 is made from canvas or other foldable material, the panel may be rolled up, folded or gathered to allow viewing through the side walls 14. The panel 17 may also be made from tempered glass, polycarbonate, or other transparent material to allow natural light to enter the mobile washing apparatus 10 or to allow spectators or customers to view the vehicle 15 during washing or detailing. If the weather is pleasant, the panel 17 may be opened as an alternative to heating or air conditioning the interior of the mobile washing apparatus 10. If the panel 17 is hinged at the top and in the open position, the panel 17 may offer additional cover or shade for vehicles, customers or spectators.

The side walls 14, the top 16 and the floor of the mobile washing apparatus 10 may be thermally insulated to maintain a comfortable environment within the mobile washing apparatus 10. In hot climates, an air conditioning unit that is configured to cool the interior of the mobile washing apparatus 10. Alternatively, in cold climates, a heating unit may be used to heat the interior of the mobile washing apparatus 10.

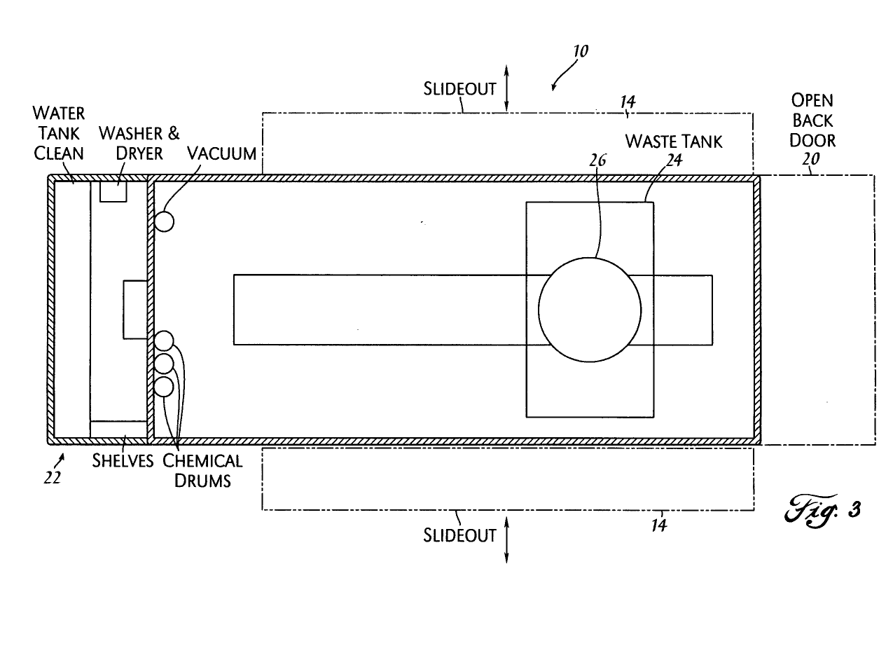

A ramp 18 may be provided on the mobile washing apparatus 10 to assist an operator in loading the vehicle 15 into the mobile washing apparatus 10. The ramp 18 may be retractable so that the operator may store the ramp 18 within the mobile washing apparatus 10. Alternatively, the ramp 18 may be a folding rear door 20 (as depicted in FIG. 3). The angle of incline of the ramp 18 may be adjusted to accommodate vehicles 15 that may have low ground clearance. In one embodiment of the invention, the floor of the mobile washing apparatus 10 may be inclined to accommodate vehicles 15 having low ground clearance.

In another embodiment of the invention, the back end of the mobile washing apparatus 10 may be raised or lowered mechanically to facilitate loading of the vehicle 15 into the mobile washing apparatus 10. These and other systems for facilitating loading the vehicle 15 into the mobile washing apparatus 10 will be apparent to those having ordinary skill in the mechanical arts. Before the vehicle 15 is loaded into the mobile washing apparatus 10, one or more stabilizers 21 may be deployed to prevent the mobile washing apparatus 10 from shifting or moving while the operator is washing or detailing the vehicle 15. The stabilizers 21 may be scissor jacks, pneumatic, hydraulic, stabilizer bars that contact the ground and the like. Other systems and methods for stabilizing the mobile washing apparatus 10 will be apparent to those having ordinary skill in the art of trailer and vehicle design.

The mobile washing apparatus 10 may have a variety of equipment and features that will facilitate washing detailing and maintaining the vehicle 15. An equipment housing 22 may be located within or adjacent to the mobile washing apparatus 10. The equipment housing 22 may be a separate room, a compartment or a location within the mobile washing apparatus 10, for example. Equipment housed within the equipment housing 22 may include a pressure washer, an electric generator, an HVAC unit, a washing machine, a clothes dryer, a water heater, an air compressor, a soap storage tank, chemical storage tanks, a water pump, a vacuum system, an oil storage tank, a trash receptacle, a key rack, an equipment control panel, satellite television equipment or a bubble machine. A solar water heater or solar electric power generating panels may be fitted to the exterior of the equipment housing 22.

The equipment housing 22 may have lockable doors or access panels to allow an operator access to the equipment yet prevent unauthorized access to expensive or technical equipment. The equipment housing 22 may also have a lockable key storage box to store customers' keys. Other equipment to facilitate washing detailing or maintaining the vehicle 15, which will be apparent to those having ordinary skill in the art of vehicle maintenance or detailing, may also be housed within the equipment housing 22 or the mobile washing apparatus 10.

The mobile washing apparatus 10 has a tank 24 that is configured to capture generally all of the waste water generated by washing the vehicle 15. The floor of the mobile washing apparatus 10 may be slightly beveled to create a slope toward a drain 26, which will direct waste water into the tank 24. Consequently, water that is used to wash the vehicle 15 tends to fall to the floor of the mobile washing apparatus 10 and flow into the drain 26 where it will be transferred to the tank 24. As a result, waste water does not flow into the surrounding environment.

The tank 24 may be configured to hold as much waste water as a water storage tank 30, which supplies clean water for washing the vehicle 15. For example, 1000 gallons of water may be carried in the water storage tank 30 and the tank 24 may be configured to hold 1000 gallons of waster water. If the waste water is being filtered and reused, a smaller capacity tank 24 may be sufficient. Alternatively, the mobile washing apparatus 10 may utilize an external water supply (not shown). In this particular instance, the tank 24 may be configured according to an estimated number of gallons of waste water that will be collected before emptying the tank is necessary. The size of the tank 24 may accordingly be reduced if waste water is filtered and reused because, in this particular instance, the tank 24 is being used for short-term waste water holding rather than for storage until the waste water may be disposed.

After the waste water is captured in the tank 24, the waste water may be stored until it can be disposed in an approved manner or it may be filtered and used for washing another vehicle. The tank 24 may be fitted to the underside of the trailer 12 or it may be fabricated as an integral component of the mobile washing apparatus 10. The tank 24 may be constructed from aluminum, stainless steel, polypropylene, high density polyethylene, fiberglass, carbon fiber and the like. The tank 24 may have a liner or coating (not shown) on its interior to help prevent corrosion caused by the waste water. The tank 24 may also be thermally insulated to prevent the waste water from freezing in cold climates. Additionally, the tank 24 may have one or more baffles (not shown) to reduce sudden shifting of the weight of the waste water during transport.

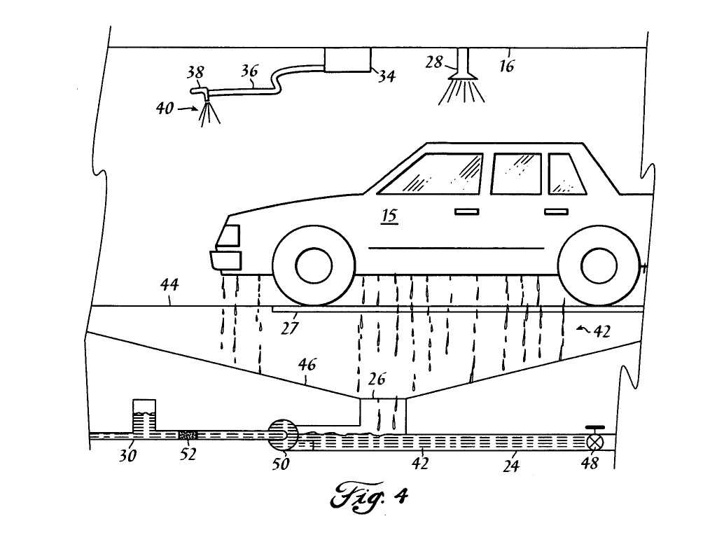

Referring now to FIG. 4, the mobile washing apparatus 10 may be driven or towed to a location. One or more tie down points (not shown) may be located about the interior of the mobile washing apparatus 10 to secure the vehicle 15. The vehicle 15 may be secured to the tie down points to safely transport the vehicle 15 within the mobile washing apparatus 10. Upon arrival at the location, the operator may deploy the stabilizers 21 (not shown) to prevent movement or shifting of the mobile washing apparatus 10. One or more side walls 14 (not shown) or the top 16 may be expanded to accommodate the dimensions of the vehicle 15. The vehicle 15 may then be driven or moved into the mobile washing apparatus 10.

The floor of the mobile washing apparatus 10 may include a turntable 27 that rotates about a generally central axis. The turntable 27 may be used to rotate the vehicle 15 within the mobile washing apparatus 10. Rotating the vehicle reduces the possibility of damaging the vehicle 15 while backing out of the mobile washing apparatus 10 after the vehicle 15 is washed or detailed. Additionally, rotating the vehicle 15 provides amusement for spectators and customers.

In one particular embodiment of the invention, one or more dispensers 28 may spray or otherwise distribute water and or soap onto the vehicle 15. The dispensers 28 may be automated using an “electric eye”, proximity sensors or the like to automatically distribute water and/or soap onto the vehicle 15 upon loading the vehicle 15 into the mobile washing apparatus 10. Alternatively, the operator may activate the dispensers 28 after the vehicle 15 is loaded. Soap, water and other chemicals may be distributed to the dispensers 28 from storage tanks 30, 32 (not shown) located in the equipment housing 22 or the mobile washing apparatus 10.

In another embodiment of the present invention, the operator may wash the vehicle 15 using a pressure washer 34. The pressure washer 34 may be mounted to the roof 16 of the mobile washing apparatus 10. A hose 36 may be connected to the pressure washer 34 to distribute pressurized water, soap and other chemicals from storage tanks 30, 32 (not shown) located in the equipment housing 22 or the mobile washing apparatus 10. The hose 36 may be of a length sufficient to allow an operator to distribute water, soap and other chemicals to all areas of the vehicle 15. The hose 36 may be mounted to a swivel-mounted boom (not shown) to facilitate moving the hose 36 around the vehicle 15.

In one embodiment of the present invention, a tubing network (not shown) having multiple quick-connect fittings (not shown) throughout the mobile washing apparatus 10 may be used. In this particular embodiment, the operator may use a shorter hose 36 having a mating quick-connect fitting (not shown) to distributed water, soap or other chemicals through the tubing network and hose to the vehicle 15. One or more quick-connect fittings (not shown) may be attached to the exterior of the mobile washing apparatus 10 to facilitate washing vehicles, such as motor coaches or airplanes, for example, that may be too large to fit within the mobile washing apparatus 10. One or more control switches (not shown) located on the mobile washing apparatus 10 may be used to control the distribution of water, soap or other chemicals through the pressure washer 34 or the hose 36. A nozzle 38 may be connected to the hose 36 to distribute water, soap or other chemicals in a spray 40. The flow and pattern of the spray 40 may be adjusted by controls on the nozzle 38.

Waste water 42 that results from washing the vehicle 15 may drip into perforations 44 on the floor of the mobile washing apparatus 10. The waste water 42 may be directed by a slope 46 into the drain 26, which collects waste water 42 in the tank 24. The slope 46 may be located beneath the floor and may be fabricated from sheets of aluminum, stainless steel and the like or molded from polypropylene or polyethylene. The angle of incline of the slope 46 need only be sufficient to promote waste water drainage into the drain 26. For example, an incline of from about 1 degree to about 30 degrees is sufficient to promote drainage on the slope 46. Alternatively, the floor of the mobile washing apparatus 10 may be slightly inclined to promote drainage of the waste water 42 into the drain 26. Other methods of collecting waste water 42 into the tank 26 will be apparent to those having ordinary skill in the art of drainage design.

The tank 24 may have a tank drain 48 that may be used to empty the contents of the tank 24. For example, waste water 42 may be collected in the tank 24 during several vehicle washes. The mobile washing apparatus 10 may then be transported to a location that is authorized to accept the collected waste water 42. The waste water 42 may then be drained through the tank drain 48 into an approved container or recycling center. The tank drain 48 may have a lock (not shown) to prevent unauthorized or accidental drainage.

Alternatively, the waste water 42 may be pumped by a tank pump 50 through a filter 52. The filter 52 may be a cartridge filter, a reverse osmosis (RO) filter, a diatomaceous earth (DE) filter or the like. Other suitable filters for the waste water 42 will be apparent to those having ordinary skill in the art of filter design. The filtered water may then be recycled into the water storage tank 30 to be reused for washing other vehicles. Filtering and reusing waste water 42 not only saves water costs but also conserves environmental resources. Additionally, fuel costs and space are conserved because not as much water, which is relatively heavy, needs to be carried and stored on the mobile washing apparatus 10.

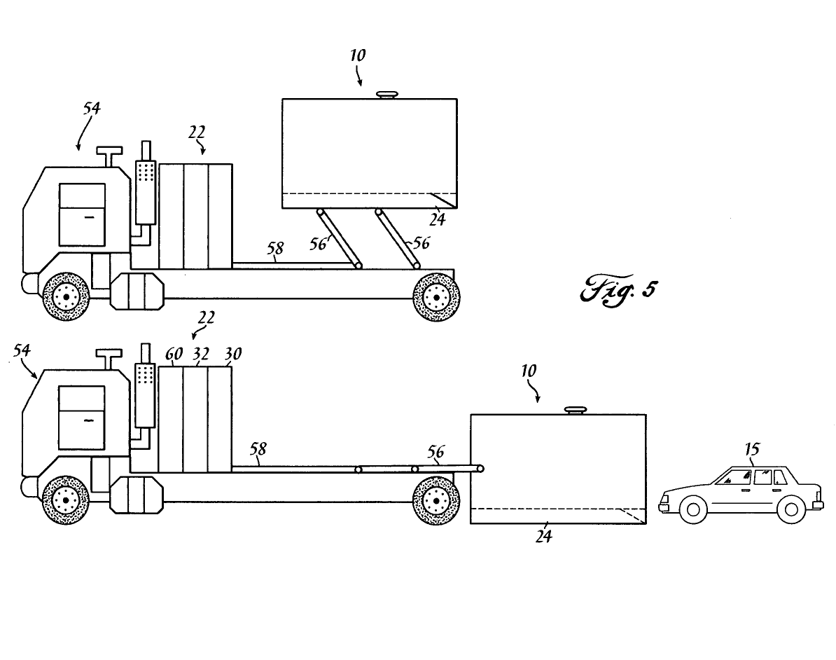

Referring now to FIG. 5, the mobile washing apparatus 10 may be a compartment that may be transported among locations by a truck 54. A lift 56 may hoist the mobile washing apparatus 10 to and from the truck 54. The lift 56 may be hydraulic, pneumatic, electro-mechanical and the like. Other systems and methods for lifting the mobile washing apparatus 10 to and from the truck 54 will be apparent to those having ordinary skill in the art of mechanical design.

The equipment housing 22 may be attached to the truck 54 as depicted or housed within the mobile washing apparatus 10. Attaching the equipment housing 22 to the truck 54, however, reduces the weight required to be lifted by the lift 56. The water storage tank 30, and storage tank 32 may be fluidly connected to the mobile washing apparatus 10 by plumbing 58. The plumbing 58 may be flexible hoses or other known method or system to fluidly connect components. The plumbing 58 thereby supplies water, soap or other chemicals to the mobile washing apparatus 10. The plumbing 58 may also supply electricity, pressurized air, hydraulic fluid or other power from the equipment housing 22 or the truck 54 to the mobile washing apparatus 10. A compartment 60 may be used to house a pressure washer, an electric generator, an HVAC unit, a washing machine, a clothes dryer, a water heater, an air compressor, a soap storage tank, chemical storage tanks, a water pump, a vacuum system, an oil storage tank, a trash receptacle, a key rack, an equipment control panel, satellite television equipment or a bubble machine.

According to this particular embodiment of the invention, the mobile washing apparatus 10 is driven to a particular location, the truck 54 is parked and the lift 56 moves the mobile washing apparatus 10 from the truck 54 to the ground. The vehicle 15 may then be loaded into the mobile washing apparatus 10 and washed, detailed or maintained. After servicing one or more vehicles 15, the lift 56 may then move the mobile washing apparatus 10 back onto the truck 54. The truck 54 may then be used to transport the mobile washing apparatus 10 to another location. Alternatively, if the equipment housing 22 is attached to the mobile washing apparatus 10, the mobile washing apparatus 10 may be detached from the truck 54. The mobile washing apparatus 10 may then be left at a particular location for a period of time.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

1. A mobile washing apparatus, comprising:
a vehicle housing; and
a tank within the vehicle housing to capture waste water generated by washing a vehicle.

2. The apparatus of claim 1, wherein the vehicle housing is a trailer.

3. The apparatus of claim 1, wherein the vehicle housing is attached to a motorized vehicle.

4. The apparatus of claim 1, wherein the vehicle housing has expandable walls.

5. The apparatus of claim 1, wherein the vehicle housing has an expandable roof.

6. The apparatus of claim 1, wherein the vehicle housing has an inclined entry ramp.

7. The apparatus of claim 1, further comprising a water supply.

8. The apparatus of claim 7, further comprising a pressure washer fluidly connected to the water supply.

9. The apparatus of claim 1, further comprising a water filter fluidly connected to the tank.

10. A self-contained mobile vehicle washing apparatus, comprising:
a vehicle housing, the vehicle housing having a floor, a roof and one or more walls;
a drain located within the floor of the vehicle housing; and
a tank fluidly connected to the drain.

11. The apparatus of claim 10, further comprising:
a water supply; and
a pressure washer fluidly connected to the water supply.

12. The apparatus of claim 11, further comprising a filter fluidly connected to the tank to filter used water from the tank, thereby creating filtered water, and to supply the filtered water to the water supply.

13. The apparatus of claim 10, wherein at least one of the one or more walls has a closed position and an expanded position.

14. The apparatus of claim 10, wherein the roof has a closed position and an expanded position.

15. The apparatus of claim 10, further comprising an equipment housing.

16. The apparatus of claim 15, further comprising equipment housed in the equipment housing, the equipment selected from the group of: an electric generator, an HVAC unit, a washing machine, a clothes dryer, a water heater, an air compressor, a soap storage tank, a water pump, a vacuum system, an oil storage tank, and a bubble machine.

17. A method for washing a vehicle comprising the steps of:
locating a mobile vehicle washing apparatus at a first location;
accepting a vehicle into the mobile vehicle washing apparatus; and
washing the vehicle.

18. The method of claim 17, further comprising the step of expanding one or more walls of the mobile vehicle washing apparatus.

19. The method of claim 17, further comprising the step of rotating the vehicle within the mobile vehicle washing apparatus.

20. The method of claim 17, further comprising the step of moving the mobile vehicle washing apparatus to a second location.
